(19) United States
(12) Patent Application Publication
(10) Pub. No.: US 2024/0369456 A1
(43) Pub. Date: Nov. 7, 2024

(54) MONITORING APPARATUS, METHOD, AND PROGRAM

(71) Applicant: NIPPON TELEGRAPH AND TELEPHONE CORPORATION, Tokyo (JP)

(72) Inventors: Eiichi ISHIDA, Tokyo (JP); Tomoya MIZOBUCHI, Tokyo (JP); Ko HARADA, Tokyo (JP)

(73) Assignee: NIPPON TELEGRAPH AND TELEPHONE CORPORATION, Tokyo (JP)

(21) Appl. No.: 18/683,769

(22) PCT Filed: Aug. 17, 2021
(86) PCT No.: PCT/JP2021/030081

§ 371 Date: Feb. 14, 2024

(51) Int. Cl. G01M 99/00

(52) U.S. Cl. CPC G01M 99/005

(57) ABSTRACT

A monitoring system according to one embodiment is a monitoring device including: a first component implemented by a containerized application; and a second component implemented by a non-containerized application, wherein the monitoring device further includes: an identification unit configured to identify, based on information on a processing status of the first component and a processing status of the second component, a component which is running out of throughput among the first and second components; a first throughput expansion unit configured to restrict data flowing to the second component and expand throughput of the second component in a case where the second component is identified as running out of throughput; and a restoration unit configured to cancel data restriction for the second component and reflect data occurring during the throughput expansion of the second component in a case where the throughput of the second component is expanded.

### TECHNICAL FIELD

The present invention relates to a monitoring device, a method, and a program.

### BACKGROUND ART

A monitoring system for collecting and monitoring application logs and metrics (for example, central processing unit (CPU) usage rate) to be monitored is widely known. Further, such a monitoring system is usually implemented and operated using containerized applications (sometimes referred to as “container applications”) using a container technology.

The monitoring system is required to be able to continuously perform monitoring against targets even when its throughput is running out. Therefore, it is important to have a technology capable of performing scale-out or scale-up on container applications in a short period of time when throughput is running out.

Throughput expansion such as scale-out or scale-up of container applications can be implemented by a container management device. For example, there is a known technology for implementing performance control such as scale-out or scale-in of a container based on metrics, for example, CPU usage rate for a container application operating under the control of a container management device (see, for example, NPL 1).

### CITATION LIST

### Non Patent Literature

[NPL 1] “Horizontal Pod Autoscaler,” kubernetes https://kubernetes.io/docs/tasks/run-application/horizontal-pod-autoscale/

### Summary of Invention

### Technical Problem

However, it is general that a non-container technology is also used in a monitoring system. For example, a database provided in the monitoring system is not suitable for an environment under the control of the container management device and typically operated outside of such environment. Accordingly, for example, the technology described in NPL 1 above cannot be applied on an as-is basis. Additionally, a certain amount of time is required to expand the database throughput without downtime, and thus it is generally difficult to expand throughput in a short period of time.

Therefore, there is a demand for a monitoring system including a containerized component and a non-containerized component such as a database, which can keep monitoring targets as needed even when throughput is running out while enabling throughput expansion.

One embodiment of the present invention has been made to address the problems above, and an object thereof is to keep monitoring targets as needed even when its throughput is running out and to enable throughput expansion in a monitoring system including a container component and a non-container component.

### Solution to Problem

In order to achieve the object stated above, a monitoring system according to one embodiment is a monitoring device including: a first component implemented by a containerized application; and a second component implemented by a non-containerized application, wherein the monitoring device further includes: an identification unit configured to identify, based on information on a processing status of the first component and a processing status of the second component, a component which is running out of throughput among the first and second components; a first throughput expansion unit configured to restrict data flowing to the second component and expand throughput of the second component in a case where the second component is identified as running out of throughput; and a restoration unit configured to cancel data restriction for the second component and reflect data occurring during the throughput expansion of the second component in a case where the throughput of the second component is expanded.

### Advantageous Effects of Invention

It is possible to keep monitoring targets as needed even when its throughput is running out and to enable throughput expansion in a monitoring system including a container component and a non-container component.

### BRIEF DESCRIPTION OF DRAWINGS

FIG. 1 is a diagram illustrating one example of overall configurations of a monitoring system and a monitoring target device according to the present embodiment.

FIG. 2 is a flowchart illustrating one example of throughput expansion processing according to the present embodiment.

FIG. 3 is a flowchart illustrating one example of details of database throughput expansion processing according to the present embodiment.

FIG. 4 is a flowchart illustrating one example of details of container throughput expansion processing according to the present embodiment.

FIG. 5 is a diagram illustrating one example of a hardware configuration of a computer.

### DESCRIPTION OF EMBODIMENTS

Hereinafter, one embodiment of the present invention will be described. In the present embodiment, a monitoring system 10 will be described, which includes a container application and a non-containerized application (sometimes referred to as “non-container application”), and can keep monitoring a monitoring target device 20 as needed even when its throughput is running out while enabling throughput expansion.

The monitoring system 10 refers to a computer system that collects data such as application logs and metrics (for example, CPU usage rate) from the monitoring target device 20, and extracts and processes specific information necessary for monitoring from such data for the purpose of displaying such information in graphical or tabulated manner, or detecting anomalies and faults. On the other hand, the monitoring target device 20 refers to a device or equipment to be monitored by the monitoring system 10.

### <Overall Configuration>

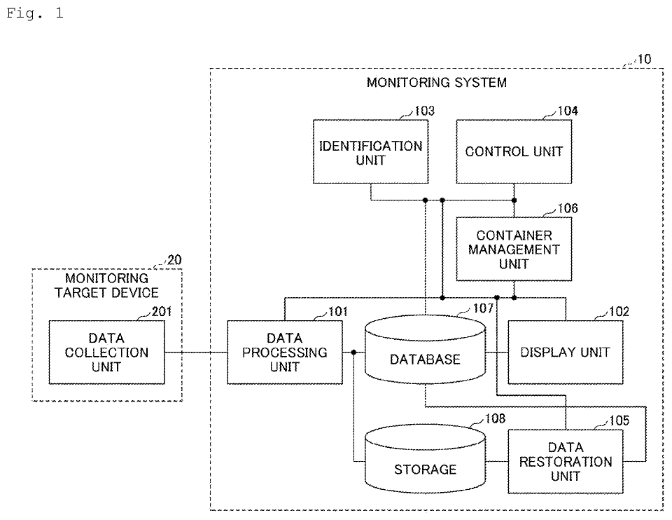

FIG. 1 shows overall configurations of the monitoring system 10 and the monitoring target device 20 according to the present embodiment. The monitoring system 10 and the monitoring target device 20 are communicatively connected via a communication network, such as the Internet, for example. Although only one monitoring target device 20 is illustrated in FIG. 1, there may be a plurality of monitoring target devices 20.

As shown in FIG. 1, the monitoring system 10 according to the present embodiment includes a data processing unit 101, a display unit 102, an identification unit 103, a control unit 104, a data restoration unit 105, a container management unit 106, a database 107, and a storage 108. The monitoring target device 20 according to the present embodiment includes a data collection unit 201.

It is assumed that the monitoring target device 20 is monitored by the data processing unit 101, the display unit 102 and the database 107. It is also assumed that the data processing unit 101 and the display unit 102 are components implemented by container applications, and the database 107 is a component implemented by non-container applications.

The data collection unit 201 acquires data such as application logs and metrics from applications running on the monitoring target device 20, and transmits the data to the monitoring system 10.

The data processing unit 101 receives data transmitted from the monitoring target device 20, extracts specific information required for monitoring from the data, creates data (hereinafter referred to as “monitoring data”) by adding predetermined information (for example, information to identify the monitoring target device 20), and stores the data in the database 107 and the storage 108.

The display unit 102 acquires the monitoring data stored in the database 107 and displays in a form of, for example, graphs or tables. The display unit 102 determines whether the monitoring data acquired from the database 107 satisfies a specific condition (for example, a condition for determining whether the monitoring target device 20 has a problem), and transmits an email indicating alert notification to a predetermined email address in a case where the monitoring data satisfies the condition.

The identification unit 103 collects information on a processing status (for example, resource usage rate) from each of the data processing unit 101, the display unit 102 and the database 107, and identifies a component which is running out of throughput. The identification unit 103 also notifies the control unit 104 of information indicating the identified component. “Running out of throughput” in a certain component refers to, for example, a case where the resource usage rate (e.g. CPU or memory usage rate) of the component exceeds a predetermined threshold.

The control unit 104 performs throughput expansion for the component (data processing unit 101, display unit 102 or database 107) indicated by the information notified from the identification unit 103. At this time, in a case where the component indicated by the information notified from the identification unit 103 is the database 107, the control unit 104 temporarily changes the setting of the data processing unit 101 to restrict (limit) storage of the monitoring data in the database 107.

The data restoration unit 105 stores (restores) monitoring data not stored during the throughput expansion of the database 107, among pieces of the monitoring data stored in the storage 108, in the database 107.

The container management unit 106 manages an execution environment for container applications and controls container applications running in the execution environment (that is, container applications that implement the data processing unit 101 and the display unit 102).

The database 107 holds the monitoring data stored by the data processing unit 101 and data restoration unit 105 in a searchable form. In response to a request from the display unit 102, the database 107 returns to the display unit 102 the monitoring data satisfying retrieval conditions included in the request. It is assumed that the database 107 is redundant so that its operation is maintained even during throughput expansion.

The storage 108 holds the monitoring data stored by the data processing unit 101. The storage 108 stores all monitoring data created by the data processing unit 101, regardless of whether the database 107 is under normal operation or throughput expansion. The monitoring data stored in the storage 108 is restored to the database 107 by the data restoration unit 105, but may be used for other purposes such as an audit trail.

Respective components of the monitoring system 10 shown in FIG. 1 may be constructed on a single server or may be distributed on a plurality of servers.

### <Throughput Expansion Processing>

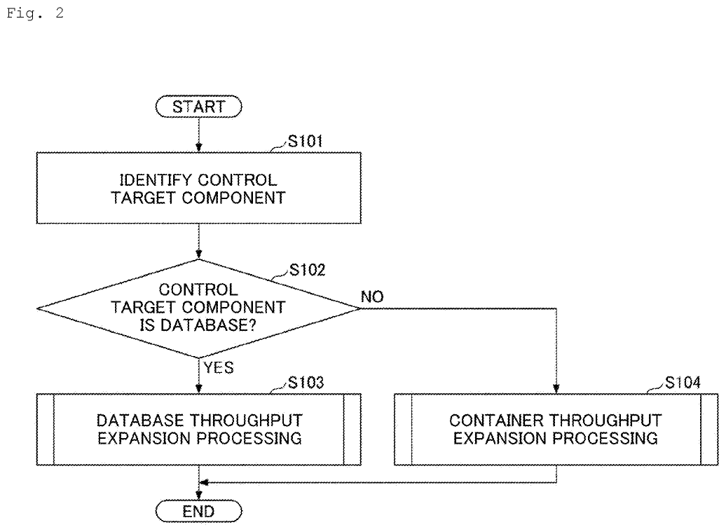

FIG. 2 shows a flowchart illustrating the throughput expansion processing according to the present embodiment. In the following description, it is assumed that any of the data processing unit 101, the display unit 102, and the database 107 is running out of throughput.

The identification unit 103 identifies, based on the information on a processing status of each of the data processing unit 101, the display unit 102 and the database 107, a control target component (that is, a component subjected to throughput expansion) (step S101).

The identification unit 103 determines whether the control target component is the database 107 or not (step S102).

In a case where it is determined that the control target component is the database 107 in step S102, the control unit 104 executes database throughput expansion processing (step S103). Details of the database throughput expansion processing will be described hereinafter.

On the other hand, in a case where it is determined that the control target component is not the database 107 in step S102, the control unit 104 executes container throughput expansion processing (step S104). Details of the container throughput expansion processing will be described hereinafter.

### <<Database Throughput Expansion Processing>>

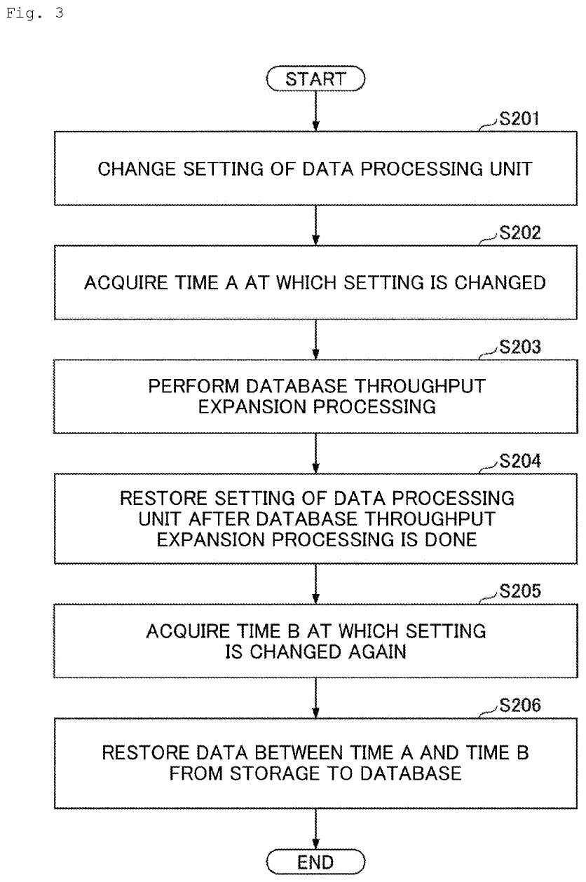

FIG. 3 shows a flowchart of the database throughput expansion processing in step S103 illustrated in FIG. 2.

The control unit 104 acquires information (setting information) indicating the current setting of the data processing unit 101, stores it in a predetermined storage area as a backup, and then changes the setting of the data processing unit 101 (step S201). More specifically, the control unit 104 changes the setting so that the data processing unit 101 stores only a part of the monitoring data in the database 107. As the predetermined storage area, any storage area can be used as long as the control unit 104 can access such a storage area.

The “setting in which the data processing unit 101 stores only a part of the monitoring data in the database 107” refers to, for example, setting in which only the monitoring data satisfying a certain condition is stored in the database 107. For example, in a case where the monitoring data is created from application logs, setting such as storing only monitoring data satisfying an alert condition such as “log level error” in the database 107 may be given. However, this is a mere example, and it is also possible to store only a part of monitoring data in the database 107 based on other conditions or rules. Thus, the operation of the database 107 is maintained even during the throughput expansion, and the monitoring data stored by the data processing unit 101 is restricted (limited).

The control unit 104 acquires a time at which the setting of the data processing unit 101 is changed in step S201 (in this database throughput expansion processing, the time is referred to as “Time A”) (step S202).

The control unit 104 then executes throughput expansion (scale-out or scale-up) of the database 107 (step S203).

After the throughput of the database 107 is expanded, the control unit 104 restores the setting of the data processing unit 101 (step S204). That is, the control unit 104 reflects the setting information stored as a backup in the predetermined storage area to the data processing unit 101, and returns the setting of the data processing unit 101 to the state before the throughput expansion.

The control unit 104 acquires a time at which the setting of the data processing unit 101 is restored in step S204 (in this database throughput expansion processing, the time is referred to as “Time B”) (step S205).

The control unit 104 then instructs the data restoration unit 105 to restore the monitoring data between Time A and Time B (step S206). Accordingly, the data restoration unit 105 restores the monitoring data from Time A to Time B from storage 108 to database 107. In a case where the restoration is completed, the data restoration unit 105 notifies the control unit 104 of its completion.

The throughput of the database 107 may run out due to the restoration. Therefore, it is preferable for the control unit 104 to calculate data traffic per unit time that satisfies a condition that the throughput of the database 107 does not run out, and then notify the data restoration unit 105 of the restore instruction that include this data traffic per unit time, as well as Times A and B. Accordingly, the data restoration unit 105 can restore the monitoring data from Time A to Time B from storage 108 to database 107 by the data traffic per unit time. Therefore, it is possible to prevent the throughput of the database 107 from running out due to the restoration.

When restoring the monitoring data from the storage 108 to the database 107, the data restoration unit 105 may, for example, assign a priority to each data type (data type such as application logs and metrics) and then restore the data in order of priority.

### <<Container Throughput Expansion Processing>>

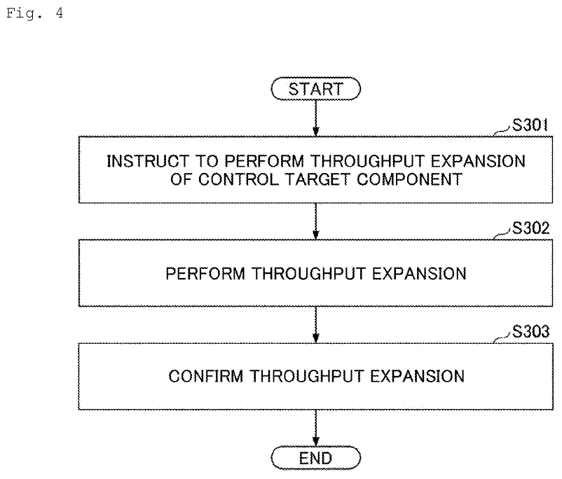

FIG. 4 shows a flowchart of the container throughput expansion processing in step S104 illustrated in FIG. 2. In the following description, the control target component is either the data processing unit 101 or the display unit 102.

The control unit 104 instructs the container management unit 106 to expand throughput of the control target component (step S301).

The container management unit 106 then executes throughput expansion (scale-out or scale-up) of the control target component (step S302). The throughput expansion can be executed by, for example, existing technology described in NPL 1.

The control unit 104 then confirms that the throughput expansion of the step S302 has been performed (step S303).

### <Hardware Configuration>

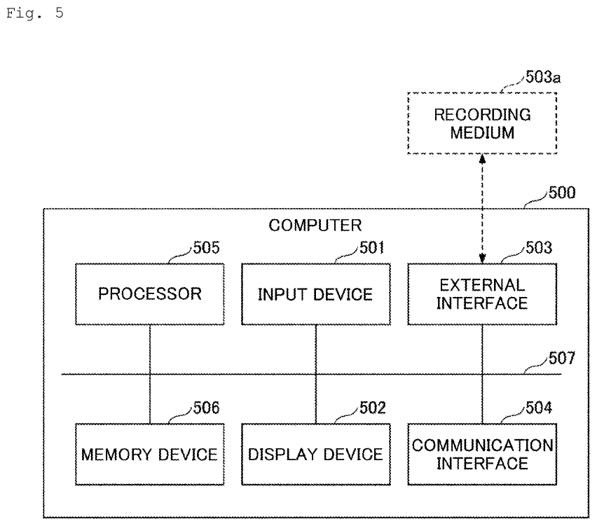

The monitoring system 10 and the monitoring target device 20 according to the present embodiment are implemented by, for example, a hardware configuration of a computer 500 illustrated in FIG. 5. The computer 500 illustrated in FIG. 5 includes an input device 501, a display device 502, an external interface 503, a communication interface 504, a processor 505, and a memory device 506. Each of these pieces of hardware is communicatively connected via a bus 507.

Examples of the input device 501 include a keyboard, a mouse, a touchscreen, and various physical buttons. The display device 502 is, for example, a display or display panel. The computer 500 may not include, for example, at least one of the input device 501 and the display device 502.

An external interface 503 is an interface with an external device such as a recording medium 503a. The computer 500 can, for example, read and write data from and to the recording medium 503a via the external interface 503. Examples of the recording medium 503a include a compact disc (CD), a digital versatile disk (DVD), a secure digital (SD) memory card, and a universal serial bus (USB) memory card.

The communication interface 504 is an interface for connecting the computer 500 to a communication network. The processor 505 may be any of various arithmetic devices, such as a CPU. The memory device 506 is, for example, any of various storage devices such as a hard disk drive (HDD), a solid-state drive (SSD), a flash memory, a random access memory (RAM), and a read only memory (ROM).

The hardware configuration of the computer 500 illustrated in FIG. 5 is a mere example and it may include a plurality of processors 505 or a plurality of memory devices 506, or may include various hardwares other than those illustrated.

### <Conclusion>

As described above, the monitoring system 10 including the component implemented by container applications and the component implemented by non-container applications can keep monitoring the monitoring target device 20 as needed even when its throughput is running out while enabling throughput expansion of each component. In a case where the non-container application is a database, the data necessary for monitoring is stored in the database while its throughput is expanded, and the data is restored after the throughput expansion is completed, thereby achieving both consecutive monitoring and throughput expansion. In the present embodiment, the component implemented by non-container applications is the database, but it is needless to say that this is a mere example and the present invention is applicable to components other than the database.

The present invention is not limited to the specifically disclosed embodiments, and various modifications, changes, variations and combinations with known techniques can be made without departing from the scope of the claims.

### REFERENCE SIGNS LIST

10: Monitoring system
20: Monitoring target device
101: Data processing unit
102: Display unit
103: Identification unit
104: Control unit
105: Data restoration unit
106: Container management unit
107: Database
108: Storage
201: Data collection unit
500: Computer
501: Input device
502: Display device
503: External interface
503a: Recording medium
504: Communication interface
505: Processor
506: Memory device
507: Bus

1. A monitoring device comprising a processor configured to execute operations comprising:
identifying, based on information on a processing status of a first application and a processing status of a second application, a third application which is running out of throughput among the first and second applications, wherein the first application is implemented by a containerized application, and the second application is implemented by a non-containerized applications;
restricting data flowing to the second application;
expanding throughput of the second application in a case where the second application is identified as running out of throughput;
canceling data restriction for the second application; and
reflecting data occurring during the throughput expansion of the second application in a case where the throughput of the second application is expanded.

2. The monitoring device according to claim 1, further comprising:
expanding throughput of the first component in a case where the first component is identified as running out of throughput.

3. The monitoring device according to claim 1, wherein
the second application is a database,
the restricting further comprises restricting data to be stored in the second application;
the expending further comprises expending throughput of the second application in a case where the second application is identified as running out of throughput,
the canceling further comprises canceling data restriction for the second application, and
the restoring further comprising restoring data occurring during the throughput expansion of the second com application ponent in a case where the throughput of the second application is expanded.

4. The monitoring device according to claim 3, wherein the restoring further comprises restoring data occurring during the throughput expansion to the second application by data traffic per unit time which satisfies a condition that the processing throughput of the second application after the throughput expansion does not run out.

5. The monitoring device according to claim 3, wherein
the data represents a plurality of data types, and
the restoring further comprises restoring data occurring during the throughput expansion to the second application in the order of priority of the data occurring during the throughput expansion based on the priority of each data type.

6. The monitoring device according to claim 1, wherein the first application further comprises:
a fourth application configured to collect and process data acquired from a monitoring target; and
a fifth application configured to display the data in a predetermined format or to send alert notification on the basis of determination on a condition.

7. A computer implemented method, comprising:
identifying, based on information on a processing status of the first application and a processing status of the second application, a third application which is running out of throughput among the first and second application;
restricting data flowing to the second application;
expanding throughput of the second application in a case where the second com application ponent is identified as running out of throughput;
cancelling data restriction for the second application; and
reflecting data occurring during the throughput expansion of the second application component in a case where the throughput of the second application is expanded.

8. A computer-readable non-transitory recording medium storing a computer-executable program instructions that when executed by a processor cause a computer system to execute operations comprising:
identifying, based on information on a processing status of a first application and a processing status of a second application, a third application which is running out of throughput among the first and second applications, wherein the first application is implemented by a containerized application, and the second application is implemented by a non-containerized application;
restricting data flowing to the second application;
expanding throughput of the second application in a case where the second application is identified as running out of throughput;
canceling data restriction for the second application; and
reflecting data occurring during the throughput expansion of the second application in a case where the throughput of the second application is expanded.

9. The computer implemented method according to claim 7, further comprising:
expanding throughput of the first component in a case where the first component is identified as running out of throughput.

10. The computer implemented method according to claim 7, wherein
the second application is a database,
the restricting further comprises restricting data to be stored in the second application;
the expending further comprises expending throughput of the second application in a case where the second application is identified as running out of throughput,
the canceling further comprises canceling data restriction for the second application, and
the restoring further comprising restoring data occurring during the throughput expansion of the second com application ponent in a case where the throughput of the second application is expanded.

11. The computer implemented method according to claim 10,
wherein the restoring further comprises restoring data occurring during the throughput expansion to the second application by data traffic per unit time which satisfies a condition that the processing throughput of the second application after the throughput expansion does not run out.

12. The computer implemented method according to claim 10, wherein
the data represents a plurality of data types, and
the restoring further comprises restoring data occurring during the throughput expansion to the second application in the order of priority of the data occurring during the throughput expansion based on the priority of each data type.

13. The computer implemented method according to claim 7, wherein the first application further comprises:
a fourth application configured to collect and process data acquired from a monitoring target; and
a fifth application configured to display the data in a predetermined format or to send alert notification based on a determined condition.

14. The computer-readable non-transitory recording medium according to claim 8, the computer-executable program instructions when executed further causing the computer system to execute operations comprising:
expanding throughput of the first component in a case where the first component is identified as running out of throughput.

15. The computer-readable non-transitory recording medium according to claim 8, wherein
the second application is a database,
the restricting further comprises restricting data to be stored in the second application;
the expending further comprises expending throughput of the second application in a case where the second application is identified as running out of throughput,
the canceling further comprises canceling data restriction for the second application, and
the restoring further comprising restoring data occurring during the throughput expansion of the second com application ponent in a case where the throughput of the second application is expanded.

16. The computer-readable non-transitory recording medium according to claim 15, wherein
the restoring further comprises restoring data occurring during the throughput expansion to the second application by data traffic per unit time which satisfies a condition that the processing throughput of the second application after the throughput expansion does not run out.

17. The computer-readable non-transitory recording medium according to claim 15, wherein
the data represents a plurality of data types, and
the restoring further comprises restoring data occurring during the throughput expansion to the second application in the order of priority of the data occurring during the throughput expansion based on the priority of each data type.

18. The computer-readable non-transitory recording medium according to claim 8, wherein the first application further comprises:
a fourth application configured to collect and process data acquired from a monitoring target; and
a fifth application configured to display the data in a predetermined format or to send alert notification based on a determined condition.
